(19) United States
(12) Patent Application Publication
(10) Pub. No.: US 2006/0111127 A1
(43) Pub. Date: May 25, 2006

(54) Method for transmitting/receiving paging information in mobile communication system

(75) Inventor: Su-Young Jang, Gyeonggi-do (KR)

Correspondence Address: FLESHNER & KIM, LLP, P.O. BOX 221200, CHANTILLY, VA, 20153, US

(73) Assignee: LG Electronics Inc.

(21) Appl. No.: 11/281,440

(22) Filed: Nov. 18, 2005

(30) Foreign Application Priority Data
Nov. 19, 2004 (KR) 95257/2004

(51) Int. Cl. H04Q 7/20

(52) U.S. Cl. 455/458

(57) ABSTRACT

A method for transmitting/receiving paging information in a mobile communication system includes transmitting information through a Broadcast Channel and then receiving paging information through a paging indicator channel based on the indicator transmitted through the Broadcast Channel. The indicator indicates whether or not paging information is transmitted through the paging indicator channel. Reception time point information and reception period information may also be transmitted to assist in receiving the paging information. By transmitting the indicator through the broadcast channel, the mobile terminal is able to save power because it only performs a “wake-up” function when the indicator has a predetermined value indicative of paging information being transmitted through the paging indicator channel.

### BACKGROUND OF THE INVENTION

1. Field of the Invention

The present invention relates to a mobile communication system, and more particularly to a system and method for transmitting/receiving paging information in a mobile communication system.

2. Description of the Related Art

Mobile communication systems allow users to wirelessly page one another and be wirelessly connected for communication any time and anywhere. This has been accomplished through controlling switching operations performed by a mobile switching center (MSC), while traveling in a service area managed by a base station (BS). In addition to voice signals, mobile communication related techniques have allowed data and multimedia signals to be transmitted.

A variety of mobile communication systems have been developed including CDMA (Code Division Multiple Access), TDMA (Time Division Multiple Access), FDMA Frequency Division Multiple Access), and GSM (Global System for Mobile Communication) systems. Another system, known as IMT-2000 (International Mobile Telecommunication-2000), has been determined as one type of 3^{rd} generation mobile communication system by an ITU (International Telecommunication Union). The IMT-2000 standard is advantageous because it supports quality multimedia services irrespective of the area of use.

Two techniques have been developed for implementing the IMT-2000 standard, namely a UMTS (Universal Mobile Telecommunications System) and CDMA 2000. These techniques have been completed by two major international organizations, called the 3GPP (3rd Generation Partnership Projects) and the 3GPP2, to provide full-fledged commercialized services in Japan, Europe, and Korea.

The UMTS is a next-generation mobile communications system which has evolved from GSM. More specifically, the UMTS is a third generation mobile communications system for providing enhanced mobile communication services using W-CDMA (Wideband Code Division Multiple Access) based on GSM.

FIG. 1 shows the construction of a typical UMTS. This UMTS includes a mobile communication terminal (user equipment: UE) 300, a UMTS terrestrial radio access network (UTRAN) 200, and a core network (CN) 100. The UTRAN includes a plurality of RNSs (Radio Network Subsystems 210, and each RNS includes an RNC 220 and a plurality of Node Bs 230 managed by the RNC.

Each Node B serves as an access point (AP) of the UTRAN with respect to the mobile communication terminal. To perform this function, each Node B receives information which has been transmitted by a physical layer of the mobile communication terminal 300 through an uplink, and transmits information to the mobile communication terminal 300 through downlink. The RNC 220 handles allocation and management of radio resources and serves as an AP with the CN 100.

A method for transmitting/receiving paging information by the UMTS constructed as described above in accordance with the related art will now be explained.

Layers of RIPs Radio Interface Protocols) between the mobile communication terminal 300 and the UTRAN 200 can be divided into a first layer (L1), a second layer (L2) and a third layer (L3) based on a lower three layers of an OSI (Open System Interconnection having 7 layers) widely known in mobile communications. An RRC (Radio Resource Control) layer corresponding to the third layer (L3) serves to control radio resources between the mobile communication terminal and the UTRAN, for which an RRC message is exchanged.

When the RRC layer of the mobile communication terminal 300 and the RRC layer of the UTRAN are connected to transmit and receive an RRC message between one another, the mobile communication terminal is considered to be in an RRC connected state. When they are not connected, the mobile communication terminal is considered to be in an idle state.

When in the RRC-connected state, the mobile communication terminal can be divided into a URA_PCH state, a CELL_PCH state, a CELL_FACH state, and/or a CELL_DCH state. In particular, when the mobile communication is in the idle state (in addition to the URA_PCH state and the CELL_PCH state), it wakes up only at each discontinuous reception (DRX) cycle to receive a PICH (Paging Indicator Channel) transmitting paging information, in order to reduce power consumption.

When in URA_PCH state or CELL_PCH state, the terminal receives and stores a UTRAN specific DRX cycle length, and discontinuously receives the PICH according to the UTRAN specific DRX cycle length.

In addition, in idle state, the terminal receives and stores a CN domain specific DRX cycle length, and discontinuously receives the PICH according to the CN domain specific DRX cycle length.

The mobile communication terminal 300 further obtains and uses a DRX cycle length corresponding to its state through system information broadcast by the RRC layer of the UTRAN.

The PICH is a physical channel used for transmitting a Paging Indicator (PI), and has a fixed data rate of SF 256. The PICH is always used in association with an S-CCPCH (Secondary Common Control Physical Channel) to which the PCH (Paging Channel) is mapped. The structure of the PICH will now be described with reference to FIG. 2.

FIG. 2 shows the structure of information transmitted through the PICH when used in a system as shown in FIG. 1. Typically, PICH information can be divided into PICH frames, each 10 ms in length and having 300 bits (B0, B1, . . . , B299). In each frame, which 288 bits (B0, . . . , B287) are used for transmitting one PI and the remaining 12 bits (B288, . . . , B299) are not used.

The UTRAN 200 periodically transmits information including the PI through the PICH to the mobile communication terminal 300. The terminal then periodically checks whether the PICH has a PI related to it. More specifically, mobile communication terminal 300 in the idle state periodically wakes up to check the PICH. If a PI is received through the PICH, the terminal receives the S-CCPCH to which the PCH is mapped, to thereby receive corresponding paging information.

The UTRAN periodically transmits system information through a BCH (Broadcast Channel) to the mobile communication terminal 300. More specifically, the UTRAN transmits an SIB (System Information Block) which is a group of information for constituting a channel and a protocol, using the BCH and transmits information for updating each type of system information to the mobile communication terminal 300 based on the radio environment, which may undergo constant changes.

However, the method for transmitting/receiving paging information in the related art mobile communication system has at least the following problems. Since paging information is received through the PICH at every DRX cycle and system information is received through the BCH separately, the mobile communication terminal must wake up at every DRX cycle in its idle state to receive the paging information and the system information. This causes power consumption of the mobile communication terminal to undesirably increase.

### BRIEF DESCRIPTION OF THE INVENTION

An object of the invention is to solve at least the above problems and/or disadvantages and to provide at least the advantages described hereinafter.

Another object of the present invention is to provide a system and method for transmitting/receiving paging information in a mobile communication system which is capable of reducing power consumption when a mobile communication terminal is in an idle state, by adding an indicator for transmission through a BCH (Broadcast Channel) that indicates whether or not paging information (Paging Indicator Channel) is transmitted through a Paging Indicator Channel (PICH).

To achieve at least the above objects in whole or part, the present invention provides in accordance with one embodiment a system and method for transmitting/receiving paging information in a mobile communication system, including: transmitting, by a UTRAN, a BCH including an indicator indicating whether a PICH is transmitted or not, to a mobile communication terminal; and receiving, by the mobile communication terminal, the PICH based on the indicator indicating whether the PICH is transmitted or not included in the received BCH.

In accordance with another embodiment, the present invention provides a system and method for transmitting paging information in a mobile communication system, including: setting an indicator in the broadcast channel to indicate whether a paging indicator channel is transmitted; and transmitting the broadcast channel including the set indicator to a mobile communication terminal.

In accordance with another embodiment, the present invention provides a system and method for receiving paging information in a mobile communication system, the method including: receiving a broadcast channel; and receiving a paging indicator channel based on an indicator included in the received broadcast channel, the indicator indicating whether the paging indicator channel is transmitted.

### BRIEF DESCRIPTION OF THE DRAWINGS

FIG. 1 shows a UMTS in the related art.

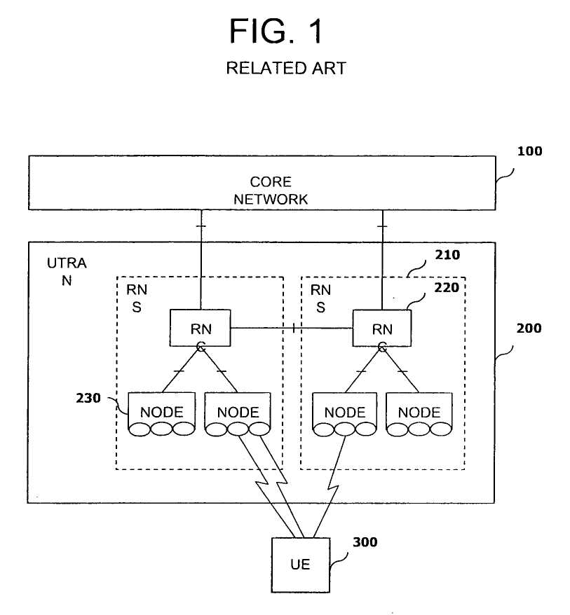

FIG. 2 shows a PICH used FIG. 1.

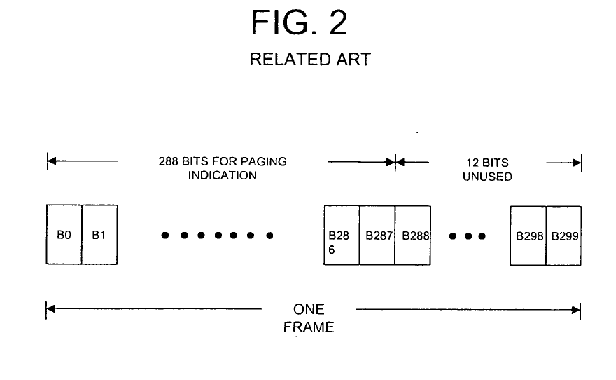

FIG. 3 is flow chart steps included in a method for transmitting/receiving paging information in a UMTS in accordance with one embodiment of the present invention.

### DETAILED DESCRIPTION OF THE INVENTION

In accordance with one embodiment, the present invention provides a system and method for transmitting/receiving paging information in a mobile communication system which effectively reduces power consumption when the terminal is in an idle state. This may be accomplished by adding an indicator for transmission in a Broadcast Channel (BCH) which indicates whether or not paging information is transmitted through a PICH (Paging Indicator Channel). Various components and procedures that would be known or understood to those skilled in the art will not be described in detail herein to prevent the features of the invention from being obscured.

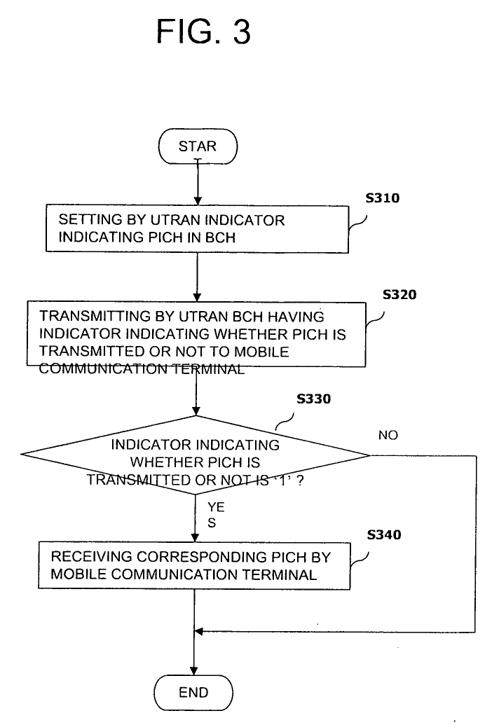

FIG. 3 is a flow chart showing steps included in a method for transmitting/receiving paging information in a UMTS (Universal Mobile Telecommunication System) in accordance with one embodiment of the present invention. This method includes using a UTRAN (UMTS Terrestrial Radio Access Network) to set an indicator indicating whether or not paging information is transmitted through a PICH (step S310). The UTRAN then transmits the set indicator to the mobile communication terminal (step S320) through a BCH.

The mobile terminal then checks whether the indicator indicating whether or not the PICH is transmitted is included or received in the BCH and whether the indicator has a predetermined value, e.g., is a ‘1’ (step S330). If so, the mobile terminal receives paging information through the PICH when the indicator indicating whether or not the detected PICH is transmitted is a “1”. Conversely, if the indicator is ‘0’, the mobile communication terminal 300 does not receive paging information through the PICH (step S350).

The method for transmitting/receiving paging information in the UMTS in accordance with the present invention will now be described in even more detail.

First, the UTRAN 200 periodically transmits system information to the mobile communication terminal 300 through a BCH. During this time, the UTRAN sets an indicator indicating whether or not paging information is transmitted to the terminal through the PICH (step S310). The indicator may, for example, include or consist of a single bit that can be variably set. For example, when the bit is ‘1’, the indicator can mean that PICH page information has been transmitted, and when the bit is ‘0’, the indicator can mean that PICH paging information has not been transmitted.

Also, the UTRAN 200 can set the bit of the indicator to be ‘0’ to indicate that PICH paging information is transmitted, and can set the bit of the indicator to be ‘1’ to indicate that PICH paging information has not been transmitted

As well as setting the indicator indicating whether PICH paging information has been transmitted, the UTRAN can also set information about a reception time point of the PICH paging information and a reception period of the indicator in the BCH, which will now be described

First, the UTRAN 200 can set, in the BCH, information about a reception time point of the PICH paging information. The reception time point information may be set, for example, as an offset value with respect to an SFN (System Frame Number) set in the BCH. Herein, the SFN indicates information related to the timing at which the SIB (System Information Block) is transmitted

Second, the UTRAN can set information about a reception period of the indicator in the BCH. The reception period information may, for example, be set as an offset value with respect to the reception time point of the indicator indicating whether the PICH paging information is transmitted or not. More particularly, the information about the reception period of the indicator may indicate a reception point of an indicator indicating whether the next PICH paging information is transmitted or not.

Accordingly, the UTRAN can transmit to the terminal through the BCH all or portion of the following: the indicator indicating whether the PICH paging information is transmitted or not, the information about the reception point of the PICH paging information, and information about the reception period of the indicator (step S320).

Upon receiving information through the BCH, the mobile communication terminal 300 checks whether the indicator indicating whether the PICH paging information is transmitted or not is included in the received BCH information, and if so whether this indicator is ‘1’ (step S330). If the indicator indicating whether the PICH paging information is transmitted or not is ‘1’, the mobile communication terminal 300 can receive the PICH paging information based on the information about the reception time point of the PICH included in additional information the received BCH (step S340). If there is no information received in the BCH about the reception time point of the PICH paging information, the mobile communication terminal can receive or refer to pre-set PICH information.

In addition, the mobile communication terminal 300 can recognize the reception time point of the indicator, indicating whether the next PICH paging information is transmitted or not, based on the information about the reception period of the indicator received through the BCH.

If the indicator indicating whether the PICH paging information is transmitted or not is ‘0’, the mobile communication terminal 300 determines that there is no paging information related to the mobile communication terminal itself, and does not receive the PICH information. Thus, the mobile communication terminal 300 can maintain its idle state thereby saving power.

The present invention therefore provides a system and method for transmitting paging information in a mobile communication system, the method comprising: setting an indicator in the broadcast channel to indicate whether a paging indicator channel is transmitted; and transmitting the broadcast channel including the set indicator to a mobile communication terminal. The method can further comprise: setting information in the broadcast channel related to a reception time point of the paging indicator channel; and setting information in the broadcast channel related to a reception period of the indicator.

Also, the present invention provides a method for receiving paging information in a mobile communication system, the method comprising: receiving a broadcast channel; and receiving a paging indicator channel based on an indicator included in the received broadcast channel, the indicator indicating whether the paging indicator channel is transmitted. Here, the paging indicator channel can be received if the indicator is ‘1’.

As so far described, the method for transmitting/receiving paging information in the mobile communication system in accordance with the present invention have the following advantages. For example, since the indicator indicating whether the PICH is transmitted or not is included in the periodically transmitted BCH, the mobile communication terminal can wake up based on the indicator indicating whether the PICH is transmitted or not. Thus, power consumption can be effectively reduced when the mobile communication terminal is in the idle state.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for transmitting/receiving paging information in a mobile communication system, comprising:
transmitting information through a broadcast channel (BCH), said information including an indicator indicating whether or not paging information is transmitted to a mobile communication terminal through a paging indicator channel (PICH); and
receiving, in the mobile communication terminal, the paging information through the PICH based on the indicator received through the BCH.

2. The method of claim 1, wherein the indicator includes a single bit whose value indicates whether or not the paging information is transmitted to the mobile communication terminal through the PICH.

3. The method of claim 2, wherein the indicator is set to a value of ‘1’ to indicate that the PICH paging information is transmitted, and is set to a value of ‘0’ to indicate that PICH paging information is not transmitted.

4. The method of claim 2, wherein the indicator being set to ‘0’ indicates that the PICH is transmitted, and the indicator being set to ‘1’ indicates that the PICH is not transmitted.

5. The method of claim 1, wherein a UTRAN transmits the indicator through the BCH.

6. The method of claim 1, further comprising:
determining information about a reception time point of the PICH paging information, and transmitting the reception time point information through the BCH in association with the indicator.

7. The method of claim 6, wherein the information about the reception time point includes an offset value with respect to a System Frame Number included in the BCH.

8. The method of claim 1, further comprising
determining information about a reception period of the indicator in the BCH; and transmitting the reception period information through the BCH in association with the indicator.

9. The method of claim 8, wherein the information about the reception period of the indicator is an offset value with respect to a reception time point of the indicator indicating whether the PICH paging information is transmitted or not.

10. The method of claim 9, wherein the information about the reception period of the indicator is a reception time point of the indicator indicating whether the next PICH paging information is transmitted or not.

11. The method of claim 1, further comprising:
determining information about a reception time point of the PICH paging information and information about a reception period of the indicator in the BCH.

12. The method of claim 1, wherein the transmitting comprises:
setting, by a UTRAN, an indicator in the BCH to indicate whether the PICH paging information is transmitted or not; and
transmitting, by the UTRAN, the BCH including the indicator indicating whether the PICH is transmitted or not to the mobile communication terminal.

13. The method of claim 11, wherein the transmitting comprises:
setting, by a UTRAN, information about a reception time point of the PICH paging information;
setting, by the UTRAN, information about a reception period of the indicator in the BCH; and
transmitting the reception time point information and the reception period information in association with the indicator to the terminal.

14. The method of claim 13, wherein receiving includes:
receiving the PICH paging information based on the reception time point information.

15. The method of claim 14, wherein receiving includes:
recognizing the reception time point of the indicator based on the reception period information.

16. The method of claim 1, wherein the receiving comprises:
checking that the indicator indicating whether the PICH paging information is transmitted is a predetermined value; and
receiving the PICH paging information when the indicator is the predetermined value.

17. The method of claim 16, wherein if the indicator is not the predetermined value, the mobile communication terminal does not receive the PICH paging information.

18. A method for transmitting paging information in a mobile communication system, the method comprising:
setting an indicator to indicate whether paging information is transmitted in a paging indicator channel; and
transmitting the indicator through a broadcast channel to a mobile communication terminal.

19. The method of claim 18, further comprising:
setting information related to a reception time point of the paging information transmitted in the paging indicator channel;
setting information related to a reception period of the indicator; and
transmitting the reception time point information and the reception period information to the mobile communication terminal through the broadcast channel.

20. A method for receiving paging information in a mobile communication system, comprising:
receiving an indicator from a broadcast channel; and
receiving paging information from a paging indicator channel based on the indicator received from the broadcast channel, the indicator indicating whether the paging information was transmitted through the paging indicator channel.

21. The method of claim 20, wherein the paging information is detected as being received through the paging indicator channel is received if the indicator corresponds to a predetermined value.

22. The method of claim 21, wherein the predetermined value is a single-bit value.
